(19) United States
(12) Patent Application Publication
(10) Pub. No.: US 2016/0215207 A1
(43) Pub. Date: Jul. 28, 2016

(54) RESIN COMPOSITION, INJECTION MATERIAL AND PACKING METHOD

(71) Applicant: SUMITOMO BAKELITE CO., LTD., Tokyo (JP)

(72) Inventors: Fumihiro Maeda, Tokyo (JP); Yasushi Arita, Tokyo (JP); Masakatsu Asami, Tokyo (JP)

(73) Assignee: SUMITOMO BAKELITE CO., LTD., Tokyo (JP)

(21) Appl. No.: 14/907,937

(22) PCT Filed: Jul. 23, 2014
(86) PCT No.: PCT/JP2014/069479

§ 371 Date: Jan. 27, 2016

(30) Foreign Application Priority Data
Jul. 26, 2013 (JP) 2013-156163

(51) Int. Cl. C09K 8/80; E21B 43/267; C09K 8/62

(52) U.S. Cl. CPC C09K 8/805; C09K 8/62; E21B 43/267

(57) ABSTRACT

A resin composition of the present invention is used for forming surface layers coating at least a part of outer surfaces of particles, the particles adapted to be packed in fractures formed in a subterranean formation. The resin composition contains an acid curing agent having an acidic group, an acid curable resin to be cured in the presence of an acid, and a polyester. The acid curing agent exists in a state that the acidic group thereof is blocked by a compound having reactivity with the acidic group. This makes it possible to provide a resin composition which can reliably cure an acid curable resin at a required place, an injection material containing such a resin composition and particles, and a packing method for packing such particles in the fractures formed in the subterranean formation.

### TECHNICAL FIELD

The present invention relates to a resin composition, an injection material and a packing method.

### RELATED ART

Recently, recovery of oily hydrocarbon or gaseous hydrocarbon (a fluid) from a subterranean formation is positively carried out. In particular, a wellbore is formed so as to penetrate the subterranean formation (a shale layer) containing the hydrocarbon, and then the hydrocarbon is recovered through the wellbore. In this case, the subterranean formation is required to have sufficient fluid permeability (conductivity) to allow the fluid to flow into the wellbore.

In order to ensure the fluid permeability of the subterranean formation, for example, hydraulic fracturing is carried out. In the hydraulic fracturing operations, a viscous liquid is first injected into the subterranean formation through the wellbore at a sufficient rate and pressure to thereby form fractures (cracks) in the subterranean formation. After that, an injection material containing particles is injected into the subterranean formation to pack the particles in the formed fractures for the purpose of preventing the fractures from being closed (blocked).

As such particles, coated particles, which are obtained by coating core particles such as silica sand or glass beads with a thermosetting resin such as an epoxy resin or a phenol resin, are well known. However, there is a problem in that a great energy is required to cure the thermosetting resin when manufacturing such coated particles.

Therefore, in order to solve such a problem, an injection material in which particles, an epoxy resin and an acid curing agent are mixed with each other is proposed (for example, see Patent document 1). This injection material is designed so as to pack the particles, the epoxy resin and the acid curing agent in the fractures formed in the subterranean formation, and then cure the epoxy resin due to the action of the acid curing agent by utilizing the heat energy of the ground. The particles are coated by a cured product of the epoxy resin and fixed in the fractures.

However, in such an injection material, the epoxy resin and the acid curing agent exist in a state that they always make contact with each other. Therefore, there is a fear that the epoxy resin may be cured at an unrequired place. For example, if the epoxy resin is cured in the middle of the wellbore, there is a case that the particles cannot be packed in the fractures to thereby lead to difficulty in the recovery of the hydrocarbon.

### PRIOR ART DOCUMENT

### Patent Document

Patent document 1: U.S. Pat. No. 5,609,207

### SUMMARY OF THE INVENTION

### Problem to be Solved by the Invention

It is an object of the present invention to provide a resin composition which can reliably cure an acid curable resin at a required place, an injection material containing such a resin composition and particles, and a packing method for packing such particles in fractures formed in a subterranean formation.

### Means for Solving Problem

In order to achieve the object, the present invention includes the following features (1) to (23).

(1) A resin composition used for forming surface layers coating at least a part of outer surfaces of particles, the particles adapted to be packed in fractures formed in a subterranean formation, comprising:

an acid curing agent having an acidic group;

an acid curable resin to be cured in the presence of an acid; and

a polyester,

wherein the acid curing agent exists in a state that the acidic group thereof is blocked by a compound having reactivity with the acidic group.

(2) The resin composition according to the above feature (1), wherein the resin composition contains a plurality of particles each formed of the polyester in which the acid curing agent is dispersed, and the acid curing agent exists in the resin composition in a state that it is separated from the acid curable resin by being dispersed in the polyester of each of the particles.

(3) The resin composition according to the above feature (1) or (2), wherein the polyester is a biodegradable polyester.

(4) The resin composition according to the above feature (3), wherein the biodegradable polyester is one selected from the group consisting of polyglycolic acid, polylactic acid, polybutylene succinate, polyethylene succinate and polycaprolactone.

(5) The resin composition according to any one of the above features (1) to (4), wherein the polyester is hydrolyzed in a water having a temperature of 80° C. within 5 days.

(6) The resin composition according to any one of the above features (1) to (5), wherein a weight average molecular weight of the polyester is in the range of 1,000 to 500,000.

(7) The resin composition according to any one of the above features (1) to (6), wherein an amount of the acid curing agent contained in the resin composition is in the range of 0.1 to 300 parts by mass with respect to 100 parts by mass of the polyester.

(8) The resin composition according to any one of the above features (1) to (7), wherein the block compound has a functional group, and the functional group is chemically bonded to the acidic group of the acid curing agent so that the acid curing agent is blocked.

(9) The resin composition according to the above feature (8), wherein the functional group of the compound includes at least one selected from the group consisting of a hydroxyl group and an amino group.

(10) The resin composition according to the above feature (8) or (9), wherein the compound is an alkyl alcohol having a hydroxyl group as the functional group.

(11) The resin composition according to the above feature (10), wherein the alkyl alcohol is a monovalent alkyl alcohol.

(12) The resin composition according to the above feature (8) or (9), wherein the compound is an alkyl amine having an amino group as the functional group.

(13) The resin composition according to any one of the above features (1) to (12), wherein in the case where the number of the acidic group of the acid curing agent is defined as “1 (one)”, the compound is contained in the resin composition so that the number of the functional group thereof is in the range of 0.1 to 1.9.

(14) The resin composition according to any one of the above features (1) to (13), wherein the acidic group of the acid curing agent includes a sulfonic acid group.

(15) The resin composition according to the above feature (14), wherein the acid curing agent includes at least one selected from the group consisting of p-toluene sulfonic acid, benzene sulfonic acid, dodecyl benzene sulfonic acid, phenol sulfonic acid, naphthalene sulfonic acid, dinonyl naphthalene sulfonic acid and dinonyl naphthalene disulfonic acid.

(16) The resin composition according to any one of the above features (1) to (15), wherein an amount of the acid curing agent contained in the resin composition is in the range of 0.1 to 20 parts by mass with respect to 100 parts by mass of the acid curable resin.

(17) The resin composition according to any one of the above features (1) to (16), wherein the acid curable resin is cured at a temperature of 100° C. or lower due to the action of the acid curing agent.

(18) The resin composition according to any one of the above features (1) to (17), wherein the acid curable resin includes at least one selected from the group consisting of a flan resin and a phenol resin.

(19) An injection material adapted to be injected into fractures formed in a subterranean formation, comprising:

particles to be packed in the fractures;

the resin material defined by any one of the above features (1) to (18); and

a fluid which transfers the particles and the resin material to the fractures.

(20) The injection material according to the above feature (19), wherein an average particle size of the particles is in the range of 100 to 3,000 μm.

(21) The injection material according to the above feature (19) or (20), wherein an amount of the particles contained in the injection material is in the range of 5 to 50 mass %.

(22) The injection material according to any one of the above features (19) to (21), wherein an amount of the resin composition contained in the injection material is in the range of 1 to 20 parts by mass with respect to 100 parts by mass of the particles.

(23) A packing method for packing particles in fractures formed in a subterranean formation by transferring the injection material defined by any one of the above features (19) to (22) to the fractures through a wellbore penetrating the subterranean formation to inject the injection material into the fractures,

wherein the acid curing agent and the acid curable resin are reacted with each other by eliminating the compound from the acid curing agent due to a pressure when the injection material is injected into the fractures and/or a temperature of the ground to cure the acid curable resin due to the action of the acid curing agent and coat the at least a part of outer surfaces of the particles with a cured product thereof.

### Effects of the Invention

According to the present invention, out of the acid curing agent and the acid curable resin each contained in the resin composition, the acid curing agent exists in the state that the acidic group thereof is blocked by, for example, being chemically bonded to the compound having the reactivity with the acidic group, and the resin composition further contains the polyester. Therefore, it is possible to prevent the acid curable resin from being cured at an unrequired place.

### BRIEF DESCRIPTION OF THE DRAWINGS

FIG. 1 is a view showing an embodiment of an injection material of the present invention.

FIG. 2 is a partial cross-sectional view showing coated particles obtained by coating particles contained in the injection material shown in FIG. 1 with a cured product of an acid curable resin.

FIG. 3 is a partial cross-sectional view showing a state that pressure is imparted to the coated particles shown in FIG. 2.

FIG. 4 is a conceptual view for explaining a method for recovering hydrocarbon from a subterranean formation.

FIG. 5 is a graph showing time-dependent changes of cured degrees of resin compositions of Example 1 and Comparative Example.

### MODE FOR CARRYING OUT THE INVENTION

Hereinafter, a resin composition, an injection material and a packing method according to the present invention will be described in detail based on preferred embodiments shown in the accompanying drawings.

First, description will be made on an injection material containing a resin composition of the present invention (an injection material of the present invention) prior to description of the resin composition of the present invention.

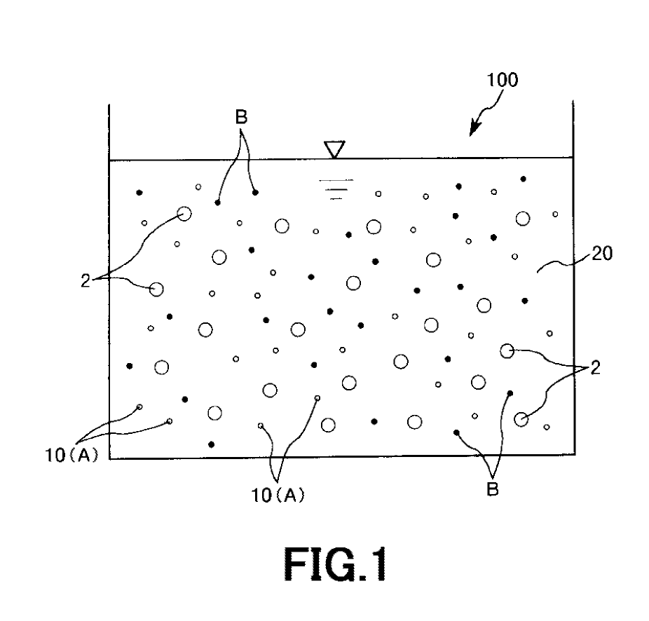

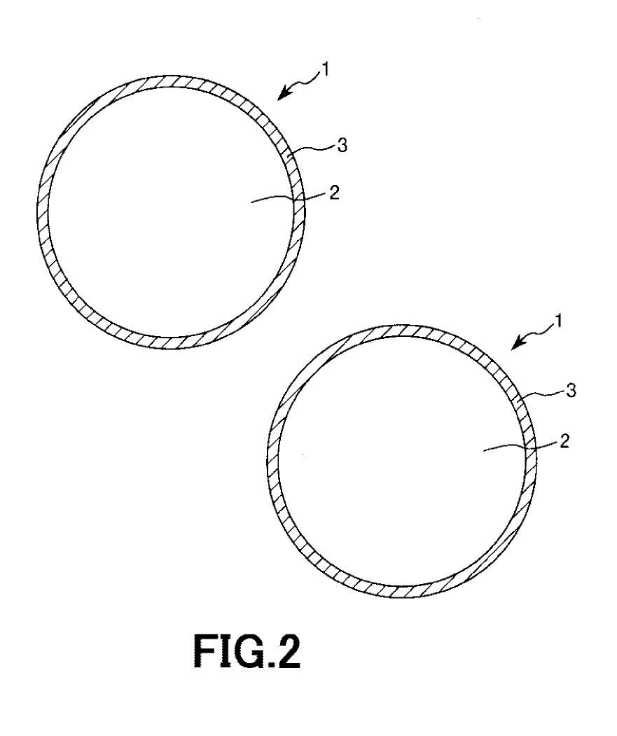

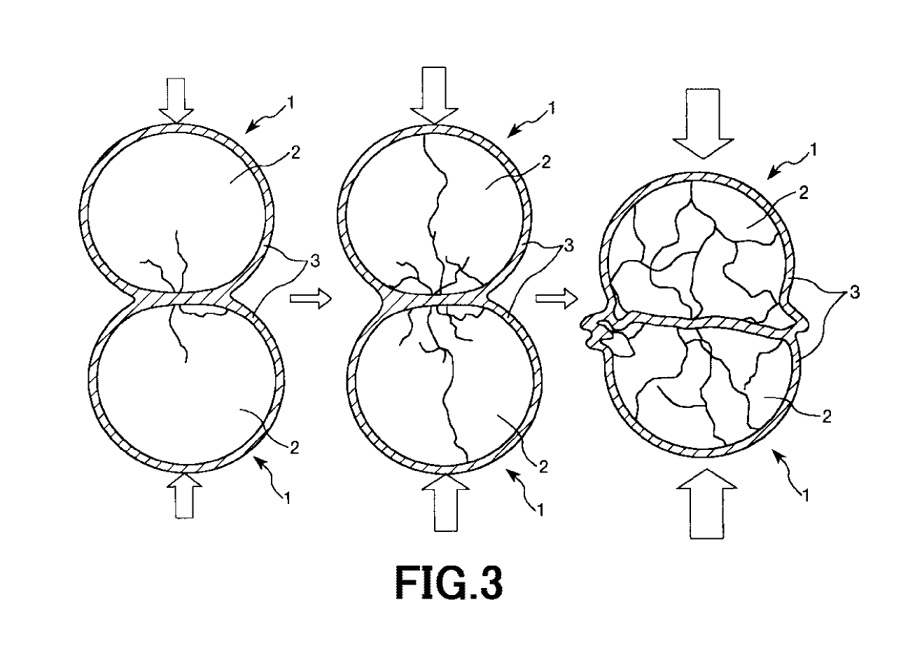

FIG. 1 is a view showing an embodiment of the injection material of the present invention, FIG. 2 is a partial cross-sectional view showing coated particles obtained by coating particles contained in the injection material shown in FIG. 1 with a cured product of an acid curable resin, and FIG. 3 is a partial cross-sectional view showing a state that pressure is imparted to the coated particles shown in FIG. 2.

The injection material of the present invention is injected into fractures formed in a subterranean formation at the time of recovering oily or gaseous hydrocarbon (a fluid) from the subterranean formation (a shale layer). Such an injection material contains particles 2 to be packed in the fractures, an acid curing agent A of which an acidic group is blocked, an acid curable resin B to be cured in the presence of an acid, that is, due to the action of the acid curing agent A, a polyester for delaying a reaction between the acid curing agent A and the acid curable resin B, and a fluid 20 for transferring the acid curing agent A and the acid curable resin B to the fractures. In this regard, the resin composition of the present invention is constituted from the acid curing agent A of which the acid group is blocked, the acid curable resin B and the polyester.

As shown in FIG. 1, an injection material 100 of this embodiment contains the particles 2, fine particles 10 each formed of the polyester in which the acid curing agent A of which the acid group is blocked is dispersed as a major component thereof, the acid curable resin B being of a particulate shape, and the fluid 20.

In a state that the particles 2 are packed in the fractures formed in the subterranean formation as shown in FIG. 2, they are coated (covered) with surface layers 3 formed of a cured product of the acid curable resin B produced due to the action of the acid curing agent A, and thus exist as coated particles 1. The coated particles 1 are packed in the fractures formed in the subterranean formation to prevent closure of the fractures and maintain fluid permeability of packed spaces of the subterranean formation in which the coated particles are packed (the fractures of the subterranean formation). This makes it possible to improve a flowing rate of hydrocarbon (a shale gas or a shale oil) contained in the subterranean formation into a wellbore communicating with the fractures.

The particles 2 serve as a propping agent in the fractures. As the particles 2, various kinds of particles having relatively high mechanical strength can be used. The particles 2 are not limited to a specific kind. Concrete examples of the particles 2 include sand particles, ceramics particles, silica particles, metal particles, walnut shells, and the like.

Among them, it is preferred that the particles 2 include at least one kind of the sand particles and the ceramics particles. The sand particles and the ceramics particles have high mechanical strength and can be easily obtained at relatively low cost.

An average particle size of the particles 2 is preferably in the range of about 100 to 3,000 μm, and more preferably in the range of about 200 to 1,000 μm. By using the particles 2 having such an average particle size, it is possible to sufficiently maintain the fluid permeability of the fractures in which the coated particles 1 are packed.

In this regard, the particles 2 may have variations in the particle size, and may contain one kind and another kind having about 10 times larger particle size than that of the one kind. Namely, when a size distribution of the particles 2 is measured, a half width of a peak of a size distribution curve shown as a chevron function may be a relatively large value.

In this regard, in FIG. 2, a cross-sectional shape of the particle 2 is depicted as a substantially circular shape, but may be an ellipsoidal shape, a polygonal shape, an irregular shape or the like. In this case, the particle size of the particle 2 is defined as a maximum length in a cross-sectional shape thereof.

In the case where the ceramics particles are used as the particles 2, it is preferred that each ceramics particle has a nearly circular shape as possible in the cross-sectional shape thereof. Such ceramics particles have especially high mechanical strength. Further, by using such ceramics particles, contacts among the coated particles 1 become point contacts when the coated particles 1 are packed in the fractures. This makes it possible to increase volumes of spaces (channels) created among the coated particles 1.

Further, natural sand particles may be directly used as the particles 2. By using such sand particles, it is possible to improve productivity of the injection material 100 and save cost thereof. Furthermore, a mixture of the ceramics particles and the sand particles may be used as the particles 2. In this case, a mixing ratio of the ceramics particles to the sand particles is preferably in the range of about 1:9 to 9:1, and more preferably in the range of about 3:7 to 7:3 in a mass ratio.

At least a part of an outer surface of each particle 2 is coated with the surface layer 3 when the particles 2 are packed in the fractures. Even if the particles 2 packed in the fractures of the subterranean formation are collapsed into pieces due to the pressure of the ground, this surface layer 3 can operate to prevent the pieces of the particles 2 from being scattered (spread) as shown in FIG. 3. For this reason, it is possible to prevent the spaces (the channels) among the coated particles 1 from being closed by the pieces of the particles 2. This makes it possible to more reliably maintain the fluid permeability of the fractures in which the coated particles 1 are packed.

An amount of the particles 2 contained in the injection material 100 is preferably in the range of about 5 to 50 mass %, and more preferably in the range of about 5 to 15 mass %. In the injection material containing the particles 2 in the above amount, it is possible to stably disperse the particles 2 regardless of a viscosity of the fluid.

The surface layers 3 preferably coat the entire outer surfaces of the particles 2 as shown in FIG. 2 when the particles 2 are packed in the fracture formed in the subterranean formation, but may coat only a part of the outer surfaces of the particles 2. Namely, in the state that the particles 2 are packed in the fractures formed in the subterranean formation, the entire outer surfaces of all of the particles 2 may be coated with the surface layers 3 or only a part of the outer surfaces of all of the particles 2 may be coated with the surface layers 3. Further, in the above state, the entire outer surfaces of some of the particles 2 may be coated with the surface layers 3 and only a part of the outer surfaces of the remaining particles 2 may be coated with the surface layers 3.

Such surface layers 3 are formed from the cured product produced by curing the acid curable resin B contained in the injection material 100 (the resin composition) due to the action of the acid curing agent A. Hereinafter, description will be made on a process in which the acid curing agent A and the acid curable resin B are reacted with each other.

The injection material 100 contains the resin composition of the present invention, that is, the acid curing agent A, the acid curable resin B to be cured in the presence of the acid, that is, the acid curable resin B to be cured due to the action of the acid curing agent A, and the polyester for delaying the reaction between the acid curing agent A and the acid curable resin B.

In such an injection material (resin composition) 100, the acid curing agent A, which has reactivity with the acid curable resin B, exists in a state that the acidic group thereof is blocked by being chemically bonded to a compound having reactivity with the acid group (hereinafter, this compound is referred to as a “block compound” on occasion). Further, the block compound is designed so as to be eliminated from the acid curing agent A under the predetermined conditions.

Furthermore, in this embodiment, in each particle 10, the acid curing agent A of which the acid group is blocked is dispersed in the polyester. In this way, in the injection material 100, the acid curing agent A and the acid curable resin B exist in a state that they are separated from each other. Moreover, as the polyester contained in each particle as the major component thereof, selected is a polyester capable of being hydrolyzed under the predetermined conditions.

In this embodiment, due to the blocking of such an acid curing agent A by the block compound and the dispersion thereof in the polyester of each particle 10, the curing of the acid curable resin B due to the action of the acid curing agent A is controlled (delayed).

Out of the blocking of the acid curing agent A by the block compound and the dispersion thereof in the polyester, first, description will be made on the blocking of the acid curing agent A by the block compound.

By blocking the acidic group of the acid curing agent A by the block compound in the injection material 100, it is possible to prevent the acid curing agent A and the acid curable resin B from being contacted (reacted) with each other to thereby cure the acid curable resin B at an unrequired place. In contrast, the acid curing agent A and the acid curable resin B can be contacted (reacted) with each other by eliminating the block compound from the acid curing agent A at a required place (that is, the fractures formed in the subterranean formation) to thereby cure the acid curable resin B.

In other words, the acid curing agent A loses the function (the reactivity) of curing the acid curable resin B by being blocked by the block compound at the unrequired place, but can cure the acid curable resin B by activating the above function due to the elimination of the block compound at the required place.

In this regard, in this specification, “blocking” means that a functional group of the block compound is chemically bonded to the acidic group of the acid curing agent A to inactivate the reactivity of progressing the curing of the acid curable resin B due to the acidic group (the reactivity with the acid curable resin B). Further, “releasing of blocking” means that the functional group of the block compound is eliminated from the acidic group of the acid curing agent A to activate the reactivity of progressing the curing of the acid curable resin B due to the acidic group.

Further, “chemical bond” has only to inactivate the reactivity of progressing the curing of the acid curable resin B due to the reaction of the acidic group of the acid curing agent A with the functional group of the block compound, and examples thereof include an intramolecular bond such as a covalent bond or a coordinate bond, and a chemical bond between molecules such as an ionic bond or a Van der Waals bond.

The acid curing agent A serves as a catalyst for promoting the curing reaction of the acid curable resin B when it makes contact with the acid curable resin B after the breaking thereof by the block compound is released and the polyester is degraded.

Such an acid curing agent A may be any compound as long as it has the acidic group, and thus can exhibit the function as the catalyst due to the action of the acidic group. Concrete examples of the acid curing agent A include: a compound having a sulfonic acid groups as the acidic group such as p-toluene sulfonic acid, benzene sulfonic acid, dodecyl benzene sulfonic acid, phenol sulfonic acid, naphthalene sulfonic acid, dinonyl naphthalene sulfonic acid, dinonyl naphthalene disulfonic acid, xylene sulfonic acid and methane sulfonic acid; a compound having a carboxyl group as the acidic group such as acetic acid, lactic acid, maleic acid, benzoic acid and fluoroacetic acid; and the like. One of them can be used or two or more of them can be used in combination.

Among them, it is preferred that the acid curing agent A is the compound having the sulfonic acid groups as the acidic group. Such a compound having the sulfonic acid group as the acidic group is a very good catalyst for the acid curable resin B, and the acidic group thereof can be reliably blocked by the block compound.

Further, it is preferred that the acid curing agent A having the sulfonic acid group as the acidic group contains at least one selected from the group consisting of the p-toluene sulfonic acid, the benzene sulfonic acid, the dodecyl benzene sulfonic acid, the phenol sulfonic acid, the naphthalene sulfonic acid, the dinonyl naphthalene sulfonic acid and the dinonyl naphthalene disulfonic acid. The acidic group of the acid curing agent A can be more reliably blocked by the block compound.

An amount of the acid curing agent A contained in the injection material 100 is preferably in the range of about 0.1 to 20 parts by mass, more preferably in the range of about 0.5 to 15 parts by mass, and even more preferably in the range of about 1 to 10 parts by mass with respect to 100 parts by mass of the acid curable resin B. By setting the amount of the acid curing agent A contained in the injection material 100 to a value falling within the above range, when the injection material 100 is injected into the fractures of the subterranean formation, even if the blocking of about half of the acid curing agent A by the block compound is not released with some causes, it is possible to secure a sufficient amount of the acid curing agent A by which the acid curable resin B can be cured.

The compound (the block compound) having the reactivity with the acidic group of the acid curing agent A blocks the acidic group of the acid curing agent A. Therefore, the block compound has a function of preventing the acid curing agent A and the acid curable resin B from being reacted with each other to cure the acid curable resin B at the unrequired place. On the other hand, the block compound also has a function of reacting the acid curing agent A and the acid curable resin B with each other by being eliminated from the acid curing agent A to cure the acid curable resin B at the required place.

Further, by blocking the acidic group of the acid curing agent A by the block compound, it is possible to use a neutral region liquid as the fluid 20 of the injection material 100 to reduce the burden on the environment. Furthermore, it is also possible to reliably prevent acid corrosion of a pipe through which the injection material 100 is passed when the injection material 100 is injected into the fractures.

Such a block compound has the functional group, and the functional group is chemically bonded to the acidic group of the acid curing agent A to block the acid curing agent.

The functional group may be any group which is reacted with the acidic group so that the block compound can be connected (chemically bonded) to the acid curing agent A. Specifically, examples of the functional group include at least one selected from a hydroxyl group, an amino group and the like. Such a block compound having the functional group exhibits excellent reactivity with the acidic group of the acid curing agent A. Therefore, the acid curing agent A can be reliably blocked by the block compound due to the reaction (the chemical bond) between the functional group and the acidic group.

Examples of the block compound having the hydroxyl group as the functional group include alcohols and phenols. Examples of the alcohols include an alkyl alcohol such as a monovalent alkyl alcohol or a polyvalent alkyl alcohol, an alkenyl alcohol, an aromatic alcohol, a heteroring-containing alcohol, and the like. Among them, it is preferred that the block compound having the hydroxyl group includes the alkyl alcohol. This makes it possible to more reliably block the acid curing agent A by the block compound.

Further, the monovalent alkyl alcohol may be either a monovalent alkyl alcohol having a linear alkyl group (a linear monovalent alkyl alcohol), a monovalent alkyl alcohol having a branch alkyl group (a branch monovalent alkyl alcohol), or a monovalent alkyl alcohol having a cyclic alkyl group (a cyclic monovalent alkyl alcohol).

Specifically, examples of the linear or branch monovalent alkyl alcohol include: methanol; ethanol; propanol such as 1-propanol or 2-propanol; butanol such as 1-butanol, 2-butanol, 2-methyl-1-propanol or 2-methyl-2-propanol; pentanol such as 1-pentanol, 2-pentanol, 3-pentanol, 2-methyl-1-butanol, 3-methyl-1-butanol, 2-methyl-2-butanol or 2,2-dimethyl-1-propanol; hexanol such as 1-hexanol, 2-hexanol, 3-hexanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-1-pentanol, 4-methyl-2-pentanol, 2,3-dimethyl-2-butanol, 3,3-dimethyl-2-butanol, 2-ethyl-1-butanol; heptanol such as 1-heptanol, 2-heptanol, 3-heptanol, 2-methyl-1-hexanol, 2-methyl-2-hexanol, 2-methyl-3-hexanol, 5-methyl-2-hexanol, 3-ethyl-3-pentanol, 2,2-dimethyl-3-pentanol, 2,4-dimethyl-3-pentanol, 4,4-dimethyl-2-pentanol or 3-methyl-1-hexanol; octanol such as 1-octanol, 2-octanol, 3-octanol, 4-methyl-3-heptanol, 6-methyl-2-heptanol, 2-ethyl-1-hexanol, 2-propyl-1-pentanol, 2-methyl-1-heptanol, 2,2-dimethyl-1-hexanol; nonanol such as 1-nonanol, 2-nonanol, 3,5,5-trimethyl-1-hexanol, 2,6-dimethyl-4-heptanol, 3-ethyl-2,2-dimethyl-3-pentanol; decanol such as 1-decanol, 2-decanol, 4-decanol, 3,7-dimethyl-1-octanol, 2,4,6-trimethyl heptanol; undecanol; dodecanol; tridecanol; tetradecanol; heptadecanol; octadecanol such as heptadecanol; nonadecanol; eicosanol; heneicosanol; tricosanol; tetracosanol; and the like. One of them can be used or two or more of them can be used in combination.

Further, examples of the cyclic monovalent alkyl alcohol (cycloalkyl alcohol) include: cyclopentanol; cycloheptanol; methyl cyclopentanol; cyclopentyl methanol; cyclohexyl methanol; 1-cyclohexyl ethanol; 2-cyclohexyl ethanol; 3-cyclohexyl propanol; 4-cyclohexyl butanol; cyclohexanols such as cyclohexanol, methyl cyclohexanol, dimethyl cyclohexanol, tetramethyl cyclohexanol, hydroxy cyclohexanol, (1S,2R,5S)-2-isopropyl-5-methyl cyclohexanol, butyl cyclohexanol and 4-t-butyl cyclohexanol; and the like. One of them can be used or two or more of them can be used in combination.

Furthermore, examples of the polyvalent alkyl alcohol include a divalent alcohol such as ethylene glycol (1,2-ethanediol), 1,2-propanediol or 1,3-propanediol, a trivalent alcohol such as glycerin, a tetravalent alcohol such as pentaerythritol, and the like. One of them can be used or two or more of them can be used in combination.

In this regard, in the case where the acid curing agent A having the sulfonic acid group as the acidic group is used, it is reacted with the block compound having the hydroxyl group as the functional group to thereby form a sulfonic acid ester bond. In this way, the acid curing agent A is blocked by the block compound. Namely, a sulfonic acid ester is produced as the acid curing agent A of which the acidic group is blocked by the block compound.

On the other hand, examples of the block compound having the amino group as the functional group include: an alkyl amine such as a monovalent alkyl amine or a polyvalent alkyl amine; an alkenyl amine; an aromatic amine; a heteroring-containing amine; and the like. Among them, it is preferred that the block compound having the amino group includes the alkyl amine. This makes it possible to more reliably block the acid curing agent A by the block compound.

Further, examples of the monovalent alkyl amine include: a monoalkyl amine such as hexyl amine, heptyl amine, octyl amine, nonyl amine, decyl amine, undecyl amine, dodecyl amine, tridecyl amine, tetradecyl amine, pentadecyl amine, hexadecyl amine, octadecyl amine, isopropyl amine, isoamyl amine or 3,3-dimethyl butyl amine; a dialkyl amine such as N-ethyl butyl amine, dibutyl amine, dipentyl amine, dihexyl amine, diheptyl amine, dioctyl amine, dinonyl amine, didecyl amine, N-methyl cyclohexyl amine or dicyclohexyl amine; a trialkyl amine such as trimethyl amine, triethyl amine, tripropyl amine, tributyl amine or trioctyl amine; and the like. One of them can be used or two or more of them can be used in combination.

Furthermore, examples of the polyvalent alkyl amine include: a diamine such as ethylene diamine, hexamethylene diamine, diethylene triamine, triethylene tetramine, tetraethylene pentamine or pentaethylene hexamine; a triamine such as bis(hexamethylene) triamine; and the like. One of them can be used or two or more of them can be used in combination.

In this regard, in the case where the acid curing agent A having the sulfonic acid group as the acidic group is used, it is reacted with the block compound having the basic amine group as the functional group to thereby form a salt by neutralization (an ionic bond). In this way, the acid curing agent A is blocked by the block compound. Namely, a sulfonic acid amine salt is produced as the acid curing agent A of which the acidic group is blocked by the block compound.

Further, in the case where the number of the acidic group of the acid curing agent A is defined as “1 (one)”, the block compound is contained in the resin composition so that the number of the functional group thereof is preferably in the range of 0.1 to 1.9, more preferably in the range of 0.3 to 1.7, and even more preferably in the range of 0.5 to 1.5.

In this regard, a method for producing the acid curing agent A of which the acidic group is blocked by the block compound is not limited to a specific method. In the case where the acid curing agent A is carboxylic acids having carboxyl groups, and the block compound is alcohols or phenols having hydroxyl groups, for example, the carboxylic acids and the alcohols or phenols are mixed with each other, and then heated by using concentrated sulfuric acid or the like as a catalyst so that a dehydration condensation reaction therebetween occurs. In this way, it is possible to produce a carboxylic acid ester which is the acid curing agent A of which the acidic group is blocked.

Further, in the case where the acid curing agent A is sulfonic acids having sulfonic acid groups, and the block compound is the alcohols or phenols having the hydroxyl groups, for example, sulfonic acid chlorides and the alcohols or phenols are reacted with each other by using pyridine as a solvent. In this way, it is possible to produce a sulfonic acid ester which is the acid curing agent A of which the acidic group is blocked.

On the other hand, in the case where the acid curing agent A is the carboxylic acids having the carboxyl groups or the sulfonic acids having the sulfonic acid groups, and the block compound is amines having amine groups, for example, the carboxylic acids or sulfonic acids and the amines are mixed with each other while being heated so that a neutralization reaction therebetween occurs. In this way, it is possible to produce a sulfonic acid salt or carboxylic acid salt which is the acid curing agent A of which the acidic group is blocked.

Next, description will be made on the dispersion of the acid curing agent A of which the acidic group is blocked in the polyester.

By dispersing the acid curing agent A of which the acidic group is blocked in the polyester of each particle 10, the acid curing agent A and the acid curable resin B exist in the injection material 100 of this embodiment in a separated state. Further, as the polyester contained in each particle 10, a polyester to be hydrolyzed under the predetermined conditions is selected.

This makes it possible to prevent the acid curing agent A and the acid curable resin B from being contacted (reacted) with each other to thereby cure the acid curable resin B at the unrequired place. In contrast, at the required place (that is, the fractures formed in the subterranean formation), the polyester is hydrolyzed so that each particle 10 becomes difficult to keep a shape thereof. As a result, the acid curing agent A is discharged (released) from each particle 10 so that the acid curing agent A and the acid curable resin B are contacted (reacted) with each other to thereby cure the acid curable resin B.

In other words, the acid curing agent A loses the function (the reactivity) of curing the acid curable resin B by being dispersed in the polyester of each particle 10 at the unrequired place, but can cure the acid curable resin B by being discharged from each particle 10 at the required place.

In the above way, the polyester exhibits the function of delaying the reaction between the acid curing agent A and the acid curable resin B. In this regard, the releasing of the blocking may occur before the acid curing agent A is discharged from each particle 10, or may occur after the acid curing agent A is discharged from each particle 10. Namely, the releasing of the blocking has only to occur at the time when the acid curing agent A and the acid curable resin B are contacted (reacted) with each other.

Further, by dispersing the acid curing agent A in the polyester of each particle 10, it is possible to use the neutral region liquid as the fluid 20 of the injection material 100 to reduce the burden on the environment. Furthermore, it is also possible to reliably prevent the acid corrosion of the pipe through which the injection material 100 is passed when the injection material 100 is injected into the fractures.

Such particles 10 are designed so as to become difficult to keep the shapes thereof preferably under conditions in which a pressure is 6,000 psi and a temperature is in the range of 30 to 120° C., and more preferably under conditions in which a pressure is 6,000 psi and a temperature is in the range of 50 to 100° C. Such a design makes it difficult for the particles 10 to keep the shapes thereof in a subterranean formation located at a relatively shallow place so that the acid curing agent A is easily discharged therefrom. Therefore, the injection material (resin composition) 100 containing such particles 10 can be appropriately used in the case where the hydrocarbon is recovered from such a subterranean formation.

In this case, the polyester contained in the particles 10 as the major component thereof is hydrolyzed preferably in a water having a temperature of 80° C. within 5 days, and preferably in the water having the temperature of 80° C. within 2 hours to 2 days. In this regard, the hydrolysis of the polyester means that a molecular weight of the polyester, a strength thereof, a weight thereof in water or the like remarkably decreases. The use of the polyester to be hydrolyzed under such conditions makes it difficult for the particles 10 to keep the shapes thereof under the above mentioned temperature and pressure conditions.

A weight average molecular weight of such a polyester is preferably in the range of about 1,000 to 500,000, and more preferably in the range of about 5,000 to 300,000. By forming the particles 10 from the polyester having the weight average molecular weight within the above mentioned range, it is possible to impart a sufficient mechanical strength to the particles 10. Further, by selecting the polyester having the weight average molecular weight within such a range, it is also possible to easily impart such a property that the particles 10 become difficult to keep the shapes thereof under the above mentioned conditions, in which the pressure is 6,000 psi and the temperature is in the range of 30 to 120° C., to the particles 10.

Further, an amount of the acid curing agent A of which the acidic group is blocked, which is contained in each particle 10 (the resin composition), is preferably in the range of 0.1 to 300 parts by mass, and more preferably in the range of 10 to 100 parts by mass with respect to 100 parts by mass of the polyester. By setting the amount of the acid curing agent A contained in the each particle 10 to be within the above range, the particles 10 can be designed so that they reliably keep the shapes thereof under different conditions from the above mentioned temperature and pressure conditions, whereas they become difficult to keep the shapes thereof under the above mentioned temperature and pressure conditions.

Furthermore, an average particle size of the particles 10 is preferably in the range of about 0.1 to 125 μm, more preferably in the range of about 0.1 to 100 μm, and even more preferably in the range of about 0.1 to 75 μm. By setting the average particle size to be within such a range, it is possible to more uniformly disperse the particles 10 in the injection material 100. Further, when the particles 10 become difficult to keep the shapes thereof, it is possible to more reliably discharge the acid curing agent A from each particle 10 so that such an acid curing agent A and the acid curable resin B make contact with each other.

Examples of the polyester contained in such particles 10 as the major component thereof include, but are not limited to, polyglycolic acid (PGA), polylactic acid, polybutylene succinate, polyethylene succinate, polycaprolactone, polyethylene terephthalate, polyethylene naphthalate, polypropylene terephthalate, polybutylene terephthalate, polyethylene diphenylate, and the like. As the polyester, one selected from the group consisting of these materials can be used or two or more selected therefrom can be used in combination.

It is preferred that such a polyester is a biodegradable polyester. Since the biodegradable polyester is degraded in the ground (in the subterranean formation) over time, it is a desirable material in that environment safety is very high.

As the biodegradable polyester, among the above mentioned materials, at least one selected from the group consisting of the polyglycolic acid, the polylactic acid, the polybutylene succinate, the polyethylene succinate and the polycaprolactone is preferable, and the polyglycolic acid is more preferable. The polyglycolic acid is a linear aliphatic polyester and has a structure including ester bonds in a main chain thereof.

Due to such a structure, particles 10 formed of the polyglycolic acid as a major component thereof have an excellent strength under non-pressed and/or non-heated conditions. Therefore, the particles 10 can firmly maintain the acid curing agent A therein. On the other hand, the polyglycolic acid is easily hydrolyzed under pressed and/or heated conditions. Therefore, the particles 10 become difficult to keep the shapes thereof to thereby more reliably discharge the acid curing agent A therefrom.

As described above, in this embodiment, due to the synergistic interaction between the blocking of the acid curing agent A by the block compound and the dispersion of the acid curing agent A of which the acidic group is blocked in the polyester, the acid curing agent A loses the function (the reactivity) of curing the acid curable resin B at the unrequired place, but can cure the acid curable resin B at the required place.

Further, in the injection material 100 having the above mentioned formulation, due to the action of the acid curing agent A which is discharged from the particles 10 and whose blocking by the block compound is released (an unblocked form of the acid curing agent A), the acid curable resin B is cured at a temperature of preferably 100° C. or lower, more preferably 75° C. or lower, and even more preferably 25° C. (room temperature) or lower. By using such an acid curable resin B, the injection material (resin composition) 100 can be especially appropriately used in the case where the hydrocarbon is recovered from the subterranean formation located at the relatively shallow place.

Furthermore, even if the acid curable resin B is cured due to the action of the acid curing agent A at the relatively low temperature, in the injection material 100, out of the acid curing agent A and the acid curable resin B, the acidic group of the acid curing agent A is blocked by the block compound and the acid curing agent A of which the acidic group is blocked exists in the state that it is dispersed in the polyester of the particles 10. Therefore, before the block compound is eliminated from the acid curing agent A or the particles 10 become difficult to keep the shapes thereof, it is possible to reliably prevent the acid curable resin B from being cured.

Examples of such an acid curable resin B include a furan resin, a phenol resin, a melamine resin, a urea resin, an oxetane resin, and the like. One of them can be used or two or more of them can be used in combination. Among them, it is preferred that the acid curable resin B includes at least one selected from the group consisting of the flan resin and the phenol resin. Since such an acid curable resin is easily cured at about room temperature in the presence of the acid such as the acid curing agent A (the acidic group of the acid curing agent A), it is especially appropriate to use in the present invention. Further, by using such a resin, it is possible to impart an especially high mechanical strength to the surface layers 3 formed from the cured product thereof and coating the particles 2.

Examples of the furan resin include a furfural resin, a furfural phenol resin, a furfural ketone resin, a furfuryl alcohol resin, a furfuryl alcohol phenol resin, and the like.

Examples of the phenol resin include a resol-type phenol resin, an alkylene etherified resol-type phenol resin, a dimethylene ether-type phenol resin, an aminomethyl-type phenol resin, a novolac-type phenol resin, an aralkyl-type phenol resin, a dicyclopentadiene-type phenol resin, and the like.

An amount of the resin composition contained in the injection material 100 is preferably in the range of about 1 to 20 parts by mass, more preferably in the range of about 1 to 15 parts by mass, and even more preferably in the range of about 5 to 15 parts by mass with respect to 100 parts by mass of the particles 2. In the case where the injection material 100 contains the resin composition in the amount of the above range, it is possible to form the surface layers (coating layers) 3 on the outer surfaces of the majority of the particles 2 when the particles 2 are packed in the fractures formed in the subterranean formation.

The fluid 20 used for preparing the injection material 100 is preferably the same as the fluid used for forming the fractures in the subterranean formation. A viscosity at 25° C. of such a fluid 20 is preferably in the range of about 10 to 500 mPa·s, more preferably in the range of about 15 to 300 mPa·s, and even more preferably in the range of about to 100 mPa·s. By using the fluid 20 having the above viscosity, it is possible to reliably form the fractures. Further, it is also possible to improve dispersibility of the particles 2 in the injection material 100 to thereby efficiently transfer the particles 2 to the fractures and pack the particles 2 therein.

Such a fluid 20 is mainly composed of water, and preferably contains a compound such a gelling agent or an electrolyte. By using the above compound, it is possible to easily and reliably adjust the viscosity of the fluid 20 to a value falling within the above range.

As the gelling agent, a polysaccharide such as cellulose, guar gum or derivatives thereof (e.g., a hydroxyethyl derivative, a carboxymethyl hydroxyethyl derivative, a hydroxypropyl derivative) is appropriately used. In this regard, a weight average molecular weight of such a polysaccharide is preferably in the range of about 100,000 to 5,000,000, and more preferably in the range of about 500,000 to 3,000,000.

Further, examples of the electrolyte include sodium chloride, potassium chloride, ammonium chloride, calcium chloride, and the like. In this regard, the fluid 20 also may be prepared by adding the gelling agent or the like to a naturally occurring electrolyte solution (e.g., seawater, a brine solution).

Next, description will be made on a method for producing the injection material 100.

The method for producing the injection material 100 according to this embodiment includes: a preparing step of preparing the acid curing agent A of which the acidic group is blocked by the block compound, and the polyester; a kneading step of kneading the acid curing agent A and the polyester with each other while being melted to obtain a kneaded product; a crushing step of solidifying the kneaded product to bring into a solidified product and then crushing the solidified product to thereby obtain the plurality of particles 10; a mixing step of mixing the particles 10, the particles 2, the acid curable resin B being of the particulate shape and the fluid 20 with each other to obtain the injection material 100.

Hereinafter, description will be made on the respective steps of the method for producing the injection material 100 in turn.

(Preparing Step)

In this step, constituent materials of the above mentioned particles 10, that is, the acid curing agent A of which the acidic group is blocked and the polyester are prepared, and then predetermined amounts thereof are weighed.

(Kneading Step)

In this step, the acid curing agent A of which the acidic group is blocked by the block compound and the polyester, which are prepared in the preparing step, are mixed (dispersively mixed), thermally melted and kneaded with each other (that is, kneaded with each other while being melted) to thereby obtain the kneaded product containing them.

Hereinafter, description will be made this step in detail.

<1> First, the predetermined amount of the acid curing agent A of which the acidic group is blocked and the predetermined amount of the polyester are mixed with each other to prepare a mixed product. Thereafter, this mixed product is uniformly crushed and stirred (dispersively stirred) at room temperature by using, for example, a mixer, a jet mill, a ball mill or the like.

<2> Next, the mixed product is kneaded by using a kneading machine while being melted by heating to obtain the kneaded product.

As the kneading machine, an extruding machine such as a heating roll, a kneader or a biaxial extruding kneader can be used, but is not especially limited thereto.

Further, a temperature (a heating temperature) at the time of melting the mixed product is slightly different depending on the constituent materials of the mixed product, but it is generally set to preferably 140 to 290° C., and more preferably 180 to 240° C. This makes it possible to bring both the acid curing agent A of which the acidic group is blocked and the polyester into a molten state while appropriately suppressing or preventing the elimination of the block compound from the acid curing agent A of which the acidic group is blocked and the hydrolysis of the polyester. Therefore, it is possible to reliably obtain the kneaded product in which the acid curing agent A of which the acidic group is blocked and the polyester exist in an uniformly dispersed state.

In this regard, in the case where the biaxial extruding kneader is used as the kneading machine, the temperature at the time of melting the mixed product is defined as a temperature of a screw section of the biaxial extruding kneader.

Further, in this step of obtaining the kneaded product, the kneaded product is obtained through the processes <1> and <2>, but may be obtained by melting the polyester by heating, adding the acid curing agent A of which the acidic group is blocked to the polyester in the molten state, and then kneading them with each other.

(Crushing Step)

In this step, the kneaded product obtained in the kneading step is solidified by cooling to bring into the solidified product, and then this solidified product is crushed to thereby obtain the particles 10.

In this case, the crushing of the kneaded product can be carried out by using a least one external force selected from the group consisting of compression, impact, shear and friction (trituration). More specifically, for the crushing of the kneaded product, one of crushers can be used or two or more thereof can be used in combination. Examples of such crushers include: an airflow type crusher such as a wing mill (produced by Sansho Industry Co., Ltd.), a mighty mill (produced by Sansho Industry Co., Ltd.) or a jet mill; a ball mill such as a vibration ball mill, a continuous rotating ball mill or a batch type ball mill; a pot mill such as a wet type pot mill or a planetary pot mill; a hammer mill; a pin mill; a roller mill; and the like. Among them, for the crushing of the kneaded product, the jet mill, the ball mill, the pot mill, the hammer mill and the pin mill are preferably used, and a jet mill having a heat waste means is more preferably used. This makes it possible to reliably obtain the particles 10 having the average particle size as described above.

A temperature (a heating temperature) at the time of crushing the kneaded product to obtain the particles 10 is preferably 40° C. or lower, and more preferably in the range of 10 to 30° C. This makes it possible to reliably prevent the particles 10 obtained by crushing the kneaded product from being brought into a molten state so that the adjacent particles 10 are aggregated together to thereby form aggregates (agglomerates). Therefore, the particles 10 can keep the particulate shapes thereof.

In this regard, examples of a method for cooling them include, but are not especially limited to, a method using a cooling medium such as liquid nitrogen or dry ice, and the like.

Further, in the present invention, the temperature at the time of crushing the kneaded product to obtain the particles 10 is defined as a temperature just after the kneaded product is crushed.

The particles 10 can be obtained through the preparing step, the kneading step and the crushing step as described above.

(Mixing Step)

In this step, the particles 10 obtained in the crushing step, the particles 2, the acid curable resin B and the fluid 20 are mixed with each other to thereby obtain the injection material 100.

The particles 10 obtained in the crushing step, the particles 2, the acid curable resin B and the fluid 20 are prepared, predetermined amounts thereof are weighed, and then mixed with each other by using, for example, a mixer or the like. In this way, it is possible to obtain the injection material 100 in which the particles 10, the particles 20 and the acid curable resin B are uniformly dispersed in the fluid 20.

In this regard, an order of adding the particles 10, the particles 20, the acid curable resin B and the fluid 20 is not limited to a specific order. As this order, for example, an order in which the particles 10 and the acid curable resin B are mixed with each other, the particles 2 are added thereto, and then the fluid 20 is further added thereto, or an order in which the particles 10, the particles 2 and the acid curable resin B are mixed with each other, and then the fluid 20 is added thereto can be selected. By doing so, it is possible to control a mixed (dispersed) state of the particles 10 and the acid curable resin B, or a coated state of the particles 2 with the acid curable resin B.

Further, the resin composition of the present invention can be obtained by omitting the addition of the particles 2 and the fluid 20 in the production of the injection material 100, that is, by mixing the particles 10 and the acid curable resin B with each other. In this regard, the resin composition of the present invention may be either a liquid containing the particles 10 or a powder containing the particles 10. Namely, in the resin composition of the present invention, the acid curable resin B may be of any state such as a liquid state or a powder state (a particle state).

Next, description will be made on a method for recovering the hydrocarbon from the subterranean formation.

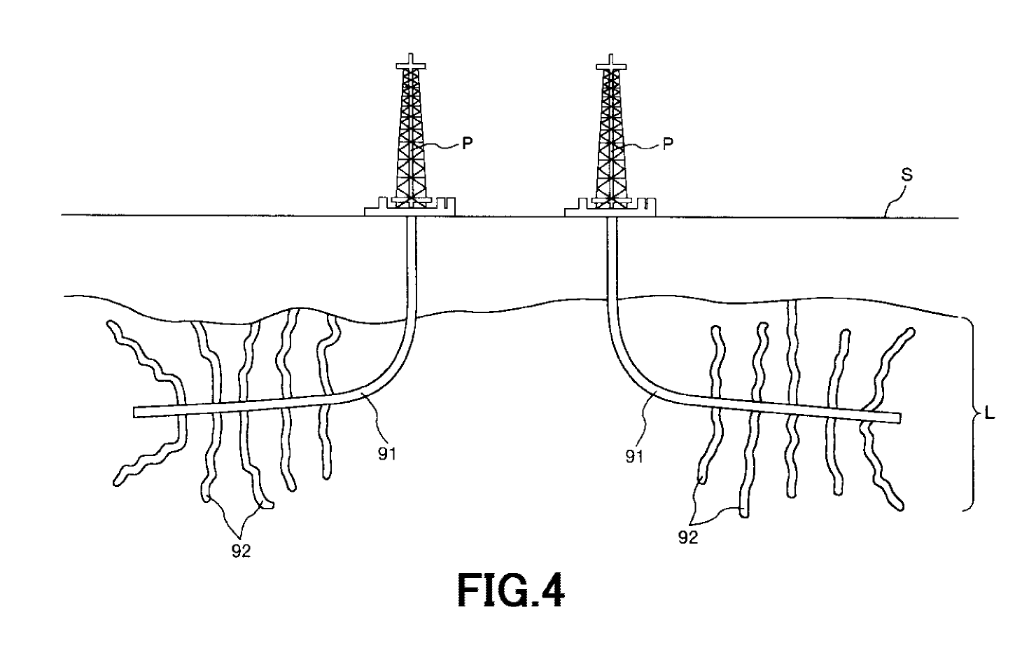

FIG. 4 is a conceptual view for explaining the method for recovering the hydrocarbon from the subterranean formation.

[1] First, as shown in FIG. 4, a wellbore 91 is dug from a land surface S to a desirable (objective) subterranean formation L containing the hydrocarbon in a vertical direction. After the wellbore 91 reaches the subterranean formation L, the digging direction thereof is changed to a horizontal direction, and then the wellbore 91 is dug in the subterranean formation L until the wellbore 91 forwards a predetermined distance in the horizontal direction.

[2] Next, a fluid is injected into the subterranean formation L through the wellbore 91 at a predetermined rate and pressure. At this time, the fluid gradually breaks down soft parts of the subterranean formation L. In this way, a plurality of fractures 92 are formed in the subterranean formation L so as to be communicated with the wellbore 91.

[3] Next, the injection material 100 is injected into the subterranean formation L through the wellbore 91 at a predetermined rate and pressure instead of the fluid. At this time, the injection material 100 is injected into each fracture 92 so that the particles 2 are packed in each fracture 92.

Further, due to a pressure at the time of injecting the injection material 100 into the fractures 92 and/or the temperature of the ground, for example, the block compound is eliminated from the acid curing agent A, and the particles 10 become difficult to keep the shapes thereof so that the acid curing agent A is discharged from the particles 10. In this way, the acid curing agent A discharged from the particles 10 makes contact with the acid curable resin B in a state that the acidic group thereof is activated so that the acid curing agent A and the acid curable resin B are reacted with each other. At this time, the acid curable resin B is cured due to the action of the acid curing agent A, and the outer surfaces of the particles 2 are coated with the cured product thereof to thereby produce the coated particles 1.

In this regard, before the injection material 100 is injected into the fractures 92, that is, when the injection material 100 is passed through the wellbore 91 or the like, the block compound is designed so that the acid curing agent A holds the blocked state of the acidic group thereof without being eliminated from the acid curing agent A, and the particles 10 are designed so as to keep (retain) the shapes thereof so that each particle 10 holds the dispersed state of the acid curing agent A in the polyester thereof. On the other hand, only under the conditions such as the temperature and the pressure at the time of injecting the injection material 100 into the fractures 92, the block compound is designed so as to be eliminated from the acid curing agent, and the particles 10 are designed so as to become difficult to keep the shapes thereof.

Therefore, before the injection material 100 is injected into the fractures 92, since the acid curing agent A is blocked by the block compound, and the acid curing agent A of which the acidic group is blocked is dispersed in the polyester of each particle 10, the curing of the acid curable resin B is prevented. On the other hand, when the injection material 100 is injected into the fractures 92, due to the eliminating of the block compound from the acid curing agent A and the discharging of the acid curing agent A from the particles 10, the acid curing agent A and the acid curable resin B are reacted with each other so that the curing of the acid curable resin B starts.

In this regard, it is preferred that this step [3] is carried out with gradually increasing the amounts of the particles 2 and/or the resin composition contained in the injection material 100. This makes it possible to reliably pack the particles 2 (the coated particles 1) in each fracture 92 at high density.

The above steps [1] to [3] correspond to the packing method of the present invention.

By packing the coated particles 1 in each fracture 92 in such a way, it is possible to prevent each fracture 92 from being closed due to the pressure of the ground. This makes it possible to enhance inflow efficiency of the hydrocarbon into the wellbore hole 91 from the subterranean formation L to thereby improve recovery efficiency of the hydrocarbon.

[4] Next, the hydrocarbon is recovered through each fracture 92 and the wellbore 91 from the subterranean formation L by using a pump P provided on the land surface S.

In this regard, the above mentioned steps [2] and [3] may be carried out at the same time by using the injection material 100. In other words, the plurality of particles 2 may be packed in each fracture 92 while forming the plurality of fractures 92 in the subterranean formation L.

While the resin composition, the injection material and the packing method according to the present invention have been described hereinabove, the present invention is not limited thereto.

For example, in this embodiment, the injection material adapted to be used for the packing method contains the acid curable resin in addition to the particles each formed of the polyester in which the acid curing agent of which the acidic group is blocked is dispersed. However, in the injection material, the polyester has only to exist between the acid curing agent of which the acidic group is blocked and the acid curable resin to thereby suppress or prevent the contact between the acid curing agent and the acid curable resin.

Therefore, for example, the injection material may contain the acid curing agent of which the acidic group is blocked in addition to particles each formed of the polyester in which the acid curable resin is dispersed. In other words, the compound contained in the particles each formed of the polyester as the major component thereof is the acid curable resin in such an injection material, whereas it is the acid curing agent of which the acidic group is blocked in the injection material of the above embodiment.

### EXAMPLES

Hereinafter, more detailed description will be made on the present invention with reference to examples thereof.

### 1. Production of Resin Composition and Injection Material

### Example 1

First, methyl p-toluene sulfonate (the acid curing agent A blocked by forming the sulfonic acid ester bond; produced by TOKYO CHEMICAL INDUSTRY CO., LTD.) as the acid curing agent A of which the acidic group was blocked, a furfuryl alcohol resin as the acid curable resin B, and polyglycolic acid (“Kuredux” produced by KUREHA CORPORATION) as the polyester were prepared, respectively.

Next, 25 parts by mass of the methyl p-toluene sulfonate was added to 100 parts by mass of the polyglycolic acid. Thereafter, they were applied into a feed section of a biaxial extruding kneader (“2D25S” produced by TOYO SEIKI Co., Ltd.) in which a temperature of a screw section was set to 200° C., and then kneaded with each other while being melted. In this way, a kneaded product in the form of pellets was obtained.

Next, this kneaded product was cooled with liquid nitrogen, and then crushed at a rotating speed of 12,000 rpm by using a fine crusher (“Exceed Mill” produced by Makino Mfg. Co., Ltd.). In this way, particles were obtained.

Next, the particles and the furfuryl alcohol resin were mixed with each other so that an amount of the methyl p-toluene sulfonate contained in the particles became 10 parts by mass with respect to 100 parts by mass of the furfuryl alcohol resin. In this way, a resin composition was obtained.

Next, sand particles having an average particle size of 250 μm and the obtained resin composition were mixed with a liquid (a fluid) used in a hydraulic fracturing method. In this way, an injection material was produced.

In this regard, an amount of the sand particles contained in the injection material was set to 9 mass %, an amount of the resin composition contained in the injection material was set to 5 parts by mass with respect to 100 parts by mass of the sand particles.

### Examples 2

A resin composition and an injection material were respectively produced in the same manner as Example 1 except that a p-toluene sulfonic acid amine salt (the acid curing agent A blocked by forming the sulfonamide bond; “NACURE 2500” produced by Kusumoto Chemicals, Ltd.) was used as the acid curing agent A of which the acidic group was blocked.

### Comparative Example

A resin composition and an injection material were produced in the same manner as Example 1 except that the addition of the polyglycolic acid (the polyester) to the resin composition and the injection material was omitted.

### 2. Curable Evaluation of Resin Composition and Injection Material

2-1. Evaluation of Resin Composition

Water was added to the resin composition obtained in each of Example 1 and Comparative Example, and then, in this state, the resin composition was heated at temperatures of 80° C. and 60° C. Thereafter, a cured degree of the resin composition was evaluated on palpation.

In this regard, the cured degree of the resin composition on palpation was evaluated based on the following criteria. 1: Liquid, 2: High viscosity liquid, 3: Gel (easily broken), 4: Rubber like solid, 5: Glass like solid (not broken).

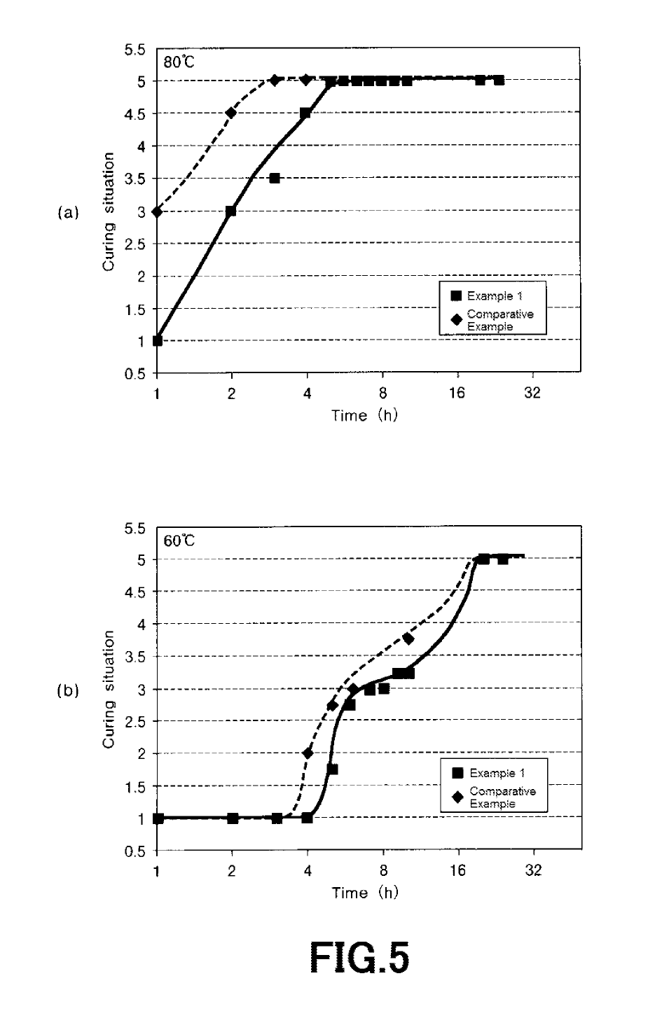

These results are shown in FIG. 5, respectively.

As shown in FIG. 5, in the resin composition of Example 1, it was confirmed that a starting time of the curing of the furfuryl alcohol resin was delayed as compared with the resin composition of Comparative Example. Namely, by making the particles in which the methyl p-toluene sulfonate was dispersed in the polyglycolic acid, it appeared that the curing of the furfuryl alcohol resin by the methyl p-toluene sulfonate could be delayed.

2-2. Evaluation of Injection Material

The injection material obtained in each of Example 1 and Example 2 was heated and pressed under conditions in which a pressure was 6,000 psi and a temperature was 80° C.

As a result, in the injection material obtained in each of Example 1 and Example 2, it was confirmed that outer surfaces of the sand particles were coated with a cured product of the furfuryl alcohol resin.

### INDUSTRIAL APPLICABILITY

A resin composition of the present invention is used for forming surface layers coating at least a part of outer surfaces of particles, which are adapted to be packed in fractures formed in a subterranean formation. This resin composition contains an acid curing agent having an acidic group, an acid curable resin to be cured in the presence of an acid, and a polyester. The acid curing agent exists in a state that the acidic group thereof is blocked by a compound having reactivity with the acidic group. This makes it possible to provide a resin composition which can reliably cure an acid curable resin at a required place, an injection material containing such a resin composition and particles, and a packing method for packing such particles in the fractures formed in the subterranean formation. Therefore, the present invention has industrial applicability.

1. A resin composition used for forming surface layers coating at least a part of outer surfaces of particles, the particles adapted to be packed in fractures formed in a subterranean formation, comprising:
an acid curing agent having an acidic group;
an acid curable resin to be cured in the presence of an acid; and
a polyester,
wherein the acid curing agent exists in a state that the acidic group thereof is blocked by a compound having reactivity with the acidic group.

2. The resin composition as claimed in claim 1, wherein the resin composition contains a plurality of particles each formed of the polyester in which the acid curing agent is dispersed, and the acid curing agent exists in the resin composition in a state that it is separated from the acid curable resin by being dispersed in the polyester of each of the particles.

3. The resin composition as claimed in claim 1, wherein the polyester is a biodegradable polyester.

4. The resin composition as claimed in claim 3, wherein the biodegradable polyester is one selected from the group consisting of polyglycolic acid, polylactic acid, polybutylene succinate, polyethylene succinate and polycaprolactone.

5. The resin composition as claimed in claim 1, wherein the polyester is hydrolyzed in a water having a temperature of 80° C. within 5 days.

6. The resin composition as claimed in claim 1, wherein a weight average molecular weight of the polyester is in the range of 1,000 to 500,000.

7. The resin composition as claimed in claim 1, wherein an amount of the acid curing agent contained in the resin composition is in the range of 0.1 to 300 parts by mass with respect to 100 parts by mass of the polyester.

8. The resin composition as claimed in claim 1, wherein the block compound has a functional group, and the functional group is chemically bonded to the acidic group of the acid curing agent so that the acid curing agent is blocked.

9. The resin composition as claimed in claim 8, wherein the functional group of the compound includes at least one selected from the group consisting of a hydroxyl group and an amino group.

10. The resin composition as claimed in claim 8, wherein the compound is an alkyl alcohol having a hydroxyl group as the functional group.

11. The resin composition as claimed in claim 10, wherein the alkyl alcohol is a monovalent alkyl alcohol.

12. The resin composition as claimed in claim 8, wherein the compound is an alkyl amine having an amino group as the functional group.

13. The resin composition as claimed in claim 1, wherein in the case where the number of the acidic group of the acid curing agent is defined as “1 (one)”, the compound is contained in the resin composition so that the number of the functional group thereof is in the range of 0.1 to 1.9.

14. The resin composition as claimed in claim 1, wherein the acidic group of the acid curing agent includes a sulfonic acid group.

15. The resin composition as claimed in claim 14, wherein the acid curing agent includes at least one selected from the group consisting of p-toluene sulfonic acid, benzene sulfonic acid, dodecyl benzene sulfonic acid, phenol sulfonic acid, naphthalene sulfonic acid, dinonyl naphthalene sulfonic acid and dinonyl naphthalene disulfonic acid.

16. The resin composition as claimed in claim 1, wherein an amount of the acid curing agent contained in the resin composition is in the range of 0.1 to 20 parts by mass with respect to 100 parts by mass of the acid curable resin.

17. The resin composition as claimed in claim 1, wherein the acid curable resin is cured at a temperature of 100° C. or lower due to the action of the acid curing agent.

18. The resin composition as claimed in claim 1, wherein the acid curable resin includes at least one selected from the group consisting of a flan resin and a phenol resin.

19. An injection material adapted to be injected into fractures formed in a subterranean formation, comprising:
particles to be packed in the fractures;
the resin material defined by claim 1; and
a fluid which transfers the particles and the resin material to the fractures.

20. The injection material as claimed in claim 19, wherein an average particle size of the particles is in the range of 100 to 3,000 μm.

21. The injection material as claimed in claim 19, wherein an amount of the particles contained in the injection material is in the range of 5 to 50 mass %.

22. The injection material as claimed in claim 19, wherein an amount of the resin composition contained in the injection material is in the range of 1 to 20 parts by mass with respect to 100 parts by mass of the particles.

23. A packing method for packing particles in fractures formed in a subterranean formation by transferring the injection material defined by claim 19 to the fractures through a wellbore penetrating the subterranean formation to inject the injection material into the fractures,
wherein the acid curing agent and the acid curable resin are reacted with each other by eliminating the compound from the acid curing agent due to a pressure when the injection material is injected into the fractures and/or a temperature of the ground to cure the acid curable resin due to the action of the acid curing agent and coat the at least a part of outer surfaces of the particles with a cured product thereof.
